(19) United States
(12) Patent Application Publication
(10) Pub. No.: US 2026/0008875 A1
(43) Pub. Date: Jan. 8, 2026

(54) ETHYLENE-BASED POLYMER WITH REVERSIBLE CROSSLINKER

(71) Applicants: Dow Global Technologies LLC, Midland, MI (US); Northwestern University, Evanston, IL (US)

(72) Inventors: John M. Torkelson, Skokie, IL (US); Boran Chen, Evanston, IL (US); Logan Fenimore, Evanston, IL (US); Colin Li Pi Shan, Lake Jackson, TX (US); Hayley A. Brown, Bellaire, TX (US); Evelyn Auyeung, Houston, TX (US); Rachel E.M. Brooner, Midland, MI (US); Stephanie M. Barbon, Midland, MI (US)

(21) Appl. No.: 18/992,446

(22) PCT Filed: Jul. 14, 2023
(86) PCT No.: PCT/US2023/027767

§ 371 Date: Jan. 8, 2025

Related U.S. Application Data
(60) Provisional application No. 63/389,707, filed on Jul. 15, 2022.

(51) Int. Cl. C08F 210/16; C08J 3/24; C08K 5/14

(52) U.S. Cl. CPC C08F 210/16; C08J 3/247; C08K 5/14; C08F 2810/20; C08J 2323/08

(57) ABSTRACT

The present disclosure provides a crosslinkable polymer composition. In an embodiment, the crosslinkable polymer composition includes an ethylene-based polymer, a free radical initiator, and 2,2,6,6-tetramethyl-4-piperidyl methacrylate disulfide (BiTEMPS methacrylate). The present disclosure provides a crosslinked composition. In an embodiment, the crosslinked composition includes an ethylene-based polymer; and 2,2,6,6-tetramethyl-4-piperidyl methacrylate disulfide (BiTEMPS methacrylate).

### BACKGROUND

Crosslinked olefin-based polymers (and crosslinked ethylene-based polymers in particular) are well-known in myriad applications because of their excellent mechanical properties, high heat stability, and outstanding chemical resistance. Unfortunately, crosslinked ethylene-based polymer (also known as thermoset polymer) is unable to be reprocessed and/or recycled due to the presence of the permanent crosslinked network within the ethylene-based polymer. Thus, the use of crosslinked ethylene-based polymer carries concomitant environmental and sustainability concerns.

The ability to reprocess and/or recycle crosslinked ethylene-based polymer has been a long-standing challenge. Consequently, the art recognizes the need for a crosslinked olefin-based polymer (and a crosslinked ethylene-based polymer in particular) that can be reprocessed and/or recycled.

### SUMMARY

The present disclosure provides a crosslinkable polymer composition. In an embodiment, the crosslinkable polymer composition includes an ethylene-based polymer, a free radical initiator, and 2,2,6,6-tetramethyl-4-piperidyl methacrylate disulfide (BiTEMPS methacrylate).

The present disclosure provides a crosslinked composition. In an embodiment, the crosslinked composition includes an ethylene-based polymer; and 2,2,6,6-tetramethyl-4-piperidyl methacrylate disulfide (BiTEMPS methacrylate).

### Definitions

All references to the Periodic Table of the Elements herein shall refer to the Periodic Table of the Elements, published and copyrighted by CRC Press, Inc., 2003. Also, any references to a Group or Groups shall be to the Group or Groups reflected in this Periodic Table of the Elements using the IUPAC system for numbering groups. Unless stated to the contrary, implicit from the context, or customary in the art, all parts and percentages are based on weight. For purposes of United States patent practice, the contents of any patent, patent application, or publication referenced herein are hereby incorporated by reference in their entirety (or the equivalent US version thereof is so incorporated by reference).

The numerical ranges disclosed herein include all values from, and including, the lower value and the upper value. For ranges containing explicit values (e.g., a range from 1, or 2, or 3 to 5, or 6, or 7) any subrange between any two explicit values is included (e.g., the range 1-7 above includes subranges from 1 to 2; from 2 to 6; from 5 to 7; from 3 to 7; from 5 to 6; etc.).

Unless stated to the contrary, implicit from the context, or customary in the art, all parts and percentages are based on weight, and all test methods are current as of the filing date of this disclosure.

The term “composition,” as used herein, refers to a mixture of materials which comprise the composition, as well as reaction products and decomposition products formed from the materials of the composition.

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

An “ethylene-based polymer” is a polymer that contains more than 50 mol % polymerized ethylene monomer (based on the total amount of polymerizable monomers) and, optionally, may contain at least one comonomer. Ethylene-based polymer includes ethylene homopolymer, and ethylene copolymer (meaning units derived from ethylene and one or more comonomers). The terms “ethylene-based polymer” and “polyethylene” may be used interchangeably. Nonlimiting examples of ethylene-based polymer (polyethylene) include low density polyethylene (LDPE) and linear polyethylene. Nonlimiting examples of linear polyethylene include linear low density polyethylene (LLDPE), ultra low density polyethylene (ULDPE), very low density polyethylene (VLDPE), multi-component ethylene-based copolymer (EPE), ethylene/α-olefin multi-block copolymers (also known as olefin block copolymer (OBC)), substantially linear, or linear, plastomers/elastomers, and high density polyethylene (HDPE). Generally, polyethylene may be produced in gas-phase, fluidized bed reactors, liquid phase slurry process reactors, or liquid phase solution process reactors, using a heterogeneous catalyst system, such as Ziegler-Natta catalyst, a homogeneous catalyst system, comprising Group 4 transition metals and ligand structures such as metallocene, non-metallocene metal-centered, heteroaryl, heterovalent aryloxyether, phosphinimine, and others. Combinations of heterogeneous and/or homogeneous catalysts also may be used in either single reactor or dual reactor configurations.

“Ethylene plastomers/elastomers” are substantially linear, or linear, ethylene/α-olefin copolymers containing homogeneous short-chain branching distribution comprising units derived from ethylene and units derived from at least one C₃-C₁₀ α-olefin comonomer. Ethylene plastomers/elastomers have a density from 0.870 g/cc to 0.917 g/cc. Nonlimiting examples of ethylene plastomers/elastomers include AFFINITY™ plastomers and elastomers (available from The Dow Chemical Company), EXACT™ Plastomers (available from ExxonMobil Chemical), Tafmer™ (available from Mitsui), Nexlene™ (available from SK Chemicals Co.), and Lucene™ (available from LG Chem Ltd.).

“High density polyethylene” (or “HDPE”) is an ethylene homopolymer or an ethylene/α-olefin copolymer with at least one C₄-C₁₀ α-olefin comonomer, or C₄-C₈ α-olefin comonomer and a density from 0.940 g/cc, or 0.945 g/cc, or 0.950 g/cc, or 0.953 g/cc to 0.955 g/cc, or 0.960 g/cc, or 0.965 g/cc, or 0.970 g/cc, or 0.975 g/cc, or 0.980 g/cc. The HDPE can be a monomodal copolymer or a multimodal copolymer. A “monomodal ethylene copolymer” is an ethylene/C₄-C₁₀ α-olefin copolymer that has one distinct peak in a gel permeation chromatography (GPC) showing the molecular weight distribution. A “multimodal ethylene copolymer” is an ethylene/C₄-C₁₀ α-olefin copolymer that has at least two distinct peaks in a GPC showing the molecular weight distribution. Multimodal includes copolymer having two peaks (bimodal) as well as copolymer having more than two peaks. Nonlimiting examples of HDPE include DOW™ High Density Polyethylene (HDPE) Resins (available from The Dow Chemical Company), ELITE™ Enhanced Polyethylene Resins (available from The Dow Chemical Company), CONTINUUM™ Bimodal Polyethylene Resins (available from The Dow Chemical Company), LUPOLEN™ (available from LyondellBasell), as well as HDPE products from Borealis, Ineos, and ExxonMobil.

“Linear low density polyethylene” (or “LLDPE”) is a linear ethylene/α-olefin copolymer containing heterogeneous short-chain branching distribution comprising units derived from ethylene and units derived from at least one C₃-C₁₀ α-olefin, or C₄-C₈ α-olefin, comonomer. LLDPE is characterized by little, if any, long chain branching, in contrast to conventional LDPE. LLDPE has a density from 0.910 g/cc to less than 0.940 g/cc. Nonlimiting examples of LLDPE include TUFLIN™ linear low density polyethylene resins (available from The Dow Chemical Company), DOWLEX™ polyethylene resins (available from the Dow Chemical Company), and MARLEX™ polyethylene (available from Chevron Phillips).

“Low density polyethylene” (or “LDPE”) consists of ethylene homopolymer, or ethylene/α-olefin copolymer comprising at least one C₃-C₁₀ α-olefin, or C₄-C₈ α-olefin, that has a density from 0.915 g/cc to less than 0.940 g/cc and contains long chain branching with broad MWD. LDPE is typically produced by way of high pressure free radical polymerization (tubular reactor or autoclave with free radical initiator). Nonlimiting examples of LDPE include MarFlex™ (Chevron Phillips), LUPOLEN™ (LyondellBasell), as well as LDPE products from Borealis, Ineos, ExxonMobil, and others.

An “olefin-based polymer,” or “polyolefin,” as used herein is a polymer that contains more than 50 mole percent polymerized olefin monomer (based on total amount of polymerizable monomers), and optionally, may contain at least one comonomer. Nonlimiting examples of olefin-based polymer include ethylene-based polymer and propylene-based polymer.

A “polymer” is a compound prepared by polymerizing monomers, whether of the same or a different type, that in polymerized form provide the multiple and/or repeating “units” or “mer units” that make up a polymer. The generic term polymer thus embraces the term homopolymer, usually employed to refer to polymers prepared from only one type of monomer, and the term copolymer, usually employed to refer to polymers prepared from at least two types of monomers. It also embraces all forms of copolymer, e.g., random, block, etc. The terms “ethylene/α-olefin polymer” and “propylene/α-olefin polymer” are indicative of copolymer as described above prepared from polymerizing ethylene or propylene respectively and one or more additional, polymerizable α-olefin monomer. It is noted that although a polymer is often referred to as being “made of” one or more specified monomers, “based on” a specified monomer or monomer type, “containing” a specified monomer content, or the like, in this context the term “monomer” is understood to be referring to the polymerized remnant of the specified monomer and not to the unpolymerized species. In general, polymers herein are referred to as being based on “units” that are the polymerized form of a corresponding monomer.

### Test Methods

Density is measured in accordance with ASTM D792 with results reported in g/cc at 25° C.

Differential scanning calorimetry (DSC) is conducted using a Mettler Toledo DSC822e differential scanning calorimeter to measure thermal properties including peak and endpoint melting temperatures and crystallinities of the virgin polymers and crosslinked compositions (network polymers). The network materials tested for most polymers are as-synthesized materials before compression molding. In the examples section, IE1 of Polymer 7 (INFUSE™ 9100) was selected to demonstrate the thermal property recovery by collecting DSC data after each successive compression molding recycle (up to three) (Table 4). A 10° C./min heating rate and a −40° C./min cooling rate were adapted for all measurements in a temperature range of −60° C. to 160° C.

Dynamic mechanical analysis (DMA). DMA experiments are conducted using a TA Instruments RSA-G2 Solid Analyzer to measure the storage modulus (E′), loss modulus (E″), and damping ratio (tan δ) of networks as a function of temperature and recycling under a nitrogen atmosphere. DMA is operated in tension mode at a frequency of 1 Hz with a 0.03% oscillatory strain. Data is collected from room temperature to 160° C. with a heating rate of 3° C./minute.

Hot creep test. The samples were compression molded into 0.7 mm thick tensile bars with bar dimension of 16 mm×4.5 mm. Bars were clamped in a 130° C. oven hanging vertically with a 60 g weight suspended from the bottom. The time required for the weight to drop to the floor of the oven (indicating sample breakage) was measured and tabulated. Experimental uncertainty was estimated using the standard deviation of three to four creep trials.

Melt index (MI or I₂) (for ethylene-based polymers) is measured in accordance with ASTM D 1238, Condition 190° C./2.16 kg with results reported in grams per 10 minutes (g/10 min). I₂₁ is measured in accordance with ASTM D 1238, Condition 190° C./21.6 kg with results reported in grams per 10 minutes (g/10 min).

### DETAILED DESCRIPTION

The present disclosure provides a crosslinkable polymer composition. In an embodiment, the crosslinkable polymer composition includes an ethylene-based polymer, a free radical initiator; and 2,2,6,6-tetramethyl-4-piperidyl methacrylate disulfide (BiTEMPS methacrylate).

### A. Ethylene-Based Polymer

The crosslinkable polymer composition includes an ethylene-based polymer. The ethylene-based polymer can be an ethylene homopolymer, an ethylene/C₃-C₁₀ α-olefin copolymer, or an ethylene C₄-C₈ α-olefin copolymer. The ethylene-based polymer has a melt index (MI) from 0.1 g/10 min to 100 g/10 min, or from 1 g/10 min to 100 g/10 min, or from 1 g/10 min to 50 g/10 min, or from 1 g/10 min to 25 g/10 min, or from 1 g/10 min to 10 g/10 min, or from 1 g/10 min to 5 g/10 min. Nonlimiting examples of suitable ethylene-based polymer include ethylene plastomer/elastomer, high density polyethylene (HDPE), linear low density polyethylene (LLDPE), low density polyethylene (LDPE), ethylene/α-olefin multi-block copolymer, and combinations thereof.

In an embodiment, the ethylene-based polymer is an ethylene plastomer/elastomer.

In an embodiment, the ethylene-based polymer is HDPE.

In an embodiment, the ethylene-based polymer is LLDPE.

In an embodiment, the ethylene-based polymer is LDPE.

In an embodiment, the ethylene-based polymer is an ethylene/Ca-olefin multi-block copolymer. The term “ethylene/α-olefin multi-block copolymer” refers to an ethylene/C₄-C₈ α-olefin multi-block copolymer consisting of ethylene and one copolymerizable C₄-C₈ α-olefin comonomer in polymerized form (and optional additives), the polymer characterized by multiple blocks or segments of two polymerized monomer units differing in chemical or physical properties, the blocks joined (or covalently bonded) in a linear manner, that is, a polymer comprising chemically differentiated units which are joined end-to-end with respect to polymerized ethylenic functionality. Ethylene/α-olefin multi-block copolymer includes block copolymer with two blocks (di-block) and more than two blocks (multi-block). The C₄-C₈ α-olefin is selected from butene, hexene, and octene. The ethylene/α-olefin multi-block copolymer is void of, or otherwise excludes, styrene (i.e., is styrene-free), and/or vinyl aromatic monomer, and/or conjugated diene. When referring to amounts of “ethylene” or “comonomer” in the copolymer, it is understood that this refers to polymerized units thereof. In some embodiments, the ethylene/α-olefin multi-block copolymer can be represented by the following formula: (AB)ₙ; where n is at least 1, preferably an integer greater than 1, such as 2, 3, 4, 5, 10, 15, 20, 30, 40, 50, 60, 70, 80, 90, 100, or higher, “A” represents a hard block or segment, and “B” represents a soft block or segment. The As and Bs are linked, or covalently bonded, in a substantially linear fashion, or in a linear manner, as opposed to a substantially branched or substantially star-shaped fashion. In other embodiments, A blocks and B blocks are randomly distributed along the polymer chain. In other words, the block copolymers usually do not have a structure as follows: AAA-AA-BBB-BB. In an embodiment, the ethylene/α-olefin multi-block copolymer does not have a third type of block, which comprises different comonomer(s). In another embodiment, each of block A and block B has monomers or comonomers substantially randomly distributed within the block. In other words, neither block A nor block B comprises two or more sub-segments (or sub-blocks) of distinct composition, such as a tip segment, which has a substantially different composition than the rest of the block.

In an embodiment, ethylene comprises the majority mole fraction of the whole ethylene/α-olefin multi-block copolymer, i.e., ethylene comprises at least 50 wt % of the whole ethylene/α-olefin multi-block copolymer. More preferably, ethylene comprises at least 60 wt %, at least 70 wt %, or at least 80 wt %, with the substantial remainder of the whole ethylene/α-olefin multi-block copolymer comprising the C₄-C₈ α-olefin comonomer. In an embodiment, the ethylene/α-olefin multi-block copolymer contains 50 wt % to 90 wt % ethylene, or 60 wt % to 85 wt % ethylene, or 65 wt % to 80 wt % ethylene. For many ethylene/octene multi-block copolymers, the composition comprises an ethylene content greater than 80 wt % of the whole ethylene/octene multi-block copolymer and an octene content of from 10 wt % to 15 wt %, or from 15 wt % to 20 wt % of the whole multi-block copolymer.

The ethylene/α-olefin multi-block copolymer includes various amounts of “hard” segments and “soft” segments. “Hard” segments are blocks of polymerized units in which ethylene is present in an amount greater than 90 wt %, or 95 wt %, or greater than 95 wt %, or greater than 98 wt %, based on the weight of the polymer, up to 100 wt %. In other words, the comonomer content (content of monomers other than ethylene) in the hard segments is less than 10 wt %, or 5 wt %, or less than 5 wt %, or less than 2 wt %, based on the weight of the polymer, and can be as low as zero. In some embodiments, the hard segments include all, or substantially all, units derived from ethylene. “Soft” segments are blocks of polymerized units in which the comonomer content (content of monomers other than ethylene) is greater than 5 wt %, or greater than 8 wt %, greater than 10 wt %, or greater than 15 wt %, based on the weight of the polymer. In an embodiment, the comonomer content in the soft segments is greater than 20 wt %, greater than 25 wt %, greater than 30 wt %, greater than 35 wt %, greater than 40 wt %, greater than 45 wt %, greater than 50 wt %, or greater than 60 wt % and can be up to 100 wt %.

The soft segments can be present in an ethylene/α-olefin multi-block copolymer from 1 wt % to 99 wt % of the total weight of the ethylene/α-olefin multi-block copolymer, or from 5 wt % to 95 wt %, from 10 wt % to 90 wt %, from 15 wt % to 85 wt %, from 20 wt % to 80 wt %, from 25 wt % to 75 wt %, from 30 wt % to 70 wt %, from 35 wt % to 65 wt %, from 40 wt % to 60 wt %, or from 45 wt % to 55 wt % of the total weight of the ethylene/α-olefin multi-block copolymer. Conversely, the hard segments can be present in similar ranges. The soft segment weight percentage and the hard segment weight percentage can be calculated based on data obtained from DSC or NMR. Such methods and calculations are disclosed in, for example, U.S. Pat. No. 7,608,668, entitled “Ethylene/α-Olefin Block Inter-Polymers,” filed on Mar. 15, 2006, in the name of Colin L. P. Shan, Lonnie Hazlitt, et. al. and assigned to Dow Global Technologies Inc., the disclosure of which is incorporated by reference herein in its entirety. In particular, hard and soft segment weight percentages and comonomer content may be determined as described in column 57 to column 63 of U.S. Pat. No. 7,608,668.

The ethylene/α-olefin multi-block copolymer comprises two or more chemically distinct regions or segments (referred to as “blocks”) joined (or covalently bonded) in a linear manner, that is, it contains chemically differentiated units which are joined end-to-end with respect to polymerized ethylenic functionality, rather than in pendent or grafted fashion. In an embodiment, the blocks differ in the amount or type of incorporated comonomer, density, amount of crystallinity, crystallite size attributable to a polymer of such composition, type or degree of tacticity (isotactic or syndiotactic), regio-regularity or regio-irregularity, amount of branching (including long chain branching or hyper-branching), homogeneity or any other chemical or physical property. Compared to block interpolymers of the prior art, including interpolymers produced by sequential monomer addition, fluxional catalysts, or anionic polymerization techniques, the present ethylene/α-olefin multi-block copolymer is characterized by unique distributions of both polymer polydispersity (PDI or Mw/Mn or MWD), polydisperse block length distribution, and/or polydisperse block number distribution, due, in an embodiment, to the effect of the shuttling agent(s) in combination with multiple catalysts used in their preparation.

In an embodiment, the ethylene/α-olefin multi-block copolymer is produced in a continuous process and possesses a polydispersity index (Mw/Mn) from 1.7 to 3.5, or from 1.8 to 3, or from 1.8 to 2.5, or from 1.8 to 2.2. When produced in a batch or semi-batch process, the ethylene/α-olefin multi-block copolymer possesses Mw/Mn from 1.0 to 3.5, or from 1.3 to 3, or from 1.4 to 2.5, or from 1.4 to 2.

In addition, the ethylene/α-olefin multi-block copolymer possesses a PDI (or Mw/Mn) fitting a Schultz-Flory distribution rather than a Poisson distribution. The present ethylene/α-olefin multi-block copolymer has both a polydisperse block distribution as well as a polydisperse distribution of block sizes. This results in the formation of polymer products having improved and distinguishable physical properties. The theoretical benefits of a polydisperse block distribution have been previously modeled and discussed in Potemkin, Physical Review E (1998) 57 (6), pp. 6902-6912, and Dobrynin, J. Chem. Phvs. (1997) 107 (21), pp 9234-9238.

In an embodiment, the present ethylene/α-olefin multi-block copolymer possesses a most probable distribution of block lengths.

In a further embodiment, the ethylene/α-olefin multi-block copolymer of the present disclosure, especially those made in a continuous, solution polymerization reactor, possess a most probable distribution of block lengths. In one embodiment of this disclosure, ethylene/α-olefin multi-block copolymers are defined as having:
(A) Mw/Mn from about 1.7 to about 3.5, at least one melting point, Tm, in degrees Celsius, and a density, d, in grams/cubic centimeter, wherein the numerical values of Tm and d correspond to the relationship:

$$Tm > - 2002.9 + 4538.5 ( d ) - 2422.2 {( d )}^{2} ,$$

and/or
(B) Mw/Mn from about 1.7 to about 3.5, and is characterized by a heat of fusion, DH in J/g, and a delta quantity, DT, in degrees Celsius defined as the temperature difference between the tallest DSC peak and the tallest Crystallization Analysis Fractionation (“CRYSTAF”) peak, wherein the numerical values of DT and DH have the following relationships:

$$DT > - 0.1299 DH + 62.81 for DH greater than zero and up to 130 J / g$$

$$DT \geq 48 ° C . for DH greater than 130 J / g$$

wherein the CRYSTAF peak is determined using at least 5 percent of the cumulative polymer, and if less than 5 percent of the polymer has an identifiable CRYSTAF peak, then the CRYSTAF temperature is 30° C.; and/or
(C) elastic recovery, Re, in percent at 300 percent strain and 1 cycle measured with a compression-molded film of the ethylene/α-olefin interpolymer, and has a density, d, in grams/cubic centimeter, wherein the numerical values of Re and d satisfy the following relationship when ethylene-α-olefin interpolymer is substantially free of crosslinked phase:

$$Re > 1481 - 1629 ( d ) ;$$

and/or
(D) has a molecular fraction which elutes between 40° C. and 130° C. when fractionated using TREF, characterized in that the fraction has a molar comonomer content of at least 5 percent higher than that of a comparable random ethylene interpolymer fraction eluting between the same temperatures, wherein said comparable random ethylene interpolymer has the same comonomer(s) and has a melt index, density and molar comonomer content (based on the whole polymer) within 10 percent of that of the ethylene/α-olefin interpolymer; and/or (E) has a storage modulus at 25° C., G′(25° C.), and a storage modulus at 100° C., G′(100° C.), wherein the ratio of G′(25° C.) to G′(100° C.) is in the range of 1:1 to 9:1.

The ethylene/α-olefin multi-block copolymer may also have:
(F) a molecular fraction which elutes between 40° C. and 130° C. when fractionated using TREF, characterized in that the fraction has a block index of at least 0.5 and up to 1 and a molecular weight distribution, Mw/Mn, greater than 1.3; and/or
(G) average block index greater than zero and up to 1.0 and a molecular weight distribution, Mw/Mn greater than 1.3.

It is understood that the ethylene/α-olefin multi-block copolymer may have one, some, all, or any combination of properties (A)-(G). Block Index can be determined as described in detail in U.S. Pat. No. 7,608,668 herein incorporated by reference for that purpose. Analytical methods for determining properties (A) through (G) are disclosed in, for example, U.S. Pat. No. 7,608,668, col. 31 line 26 through col. 35 line 44, which is herein incorporated by reference for that purpose.

In an embodiment, the ethylene/α-olefin multi-block copolymer has hard segments and soft segments, is styrene-free, consists of only (i) ethylene and (ii) a C₄-C₈ α-olefin or C₈ α-olefin (and optional additives), and is defined as having a Mw/Mn from 1.7 to 3.5, at least one melting point, Tm, in degrees Celsius, and a density, d, in grams/cubic centimeter, wherein the numerical values of Tm and d correspond to the relationship:

$$Tm > - 2002.9 + 4538.5 ( d ) - 2422.2 {( d )}^{2} ,$$

where the density, d, is from 0.850 g/cc, or 0.860 g/cc, or 0.870 g/cc to 0.875 g/cc, or 0.877 g/cc, or 0.880 g/cc, or 0.890 g/cc; and the melting point, Tm, is from 110° C., or 115° C., or 120° C. to 125° C., or 130° C., or 135° C.

In an embodiment, the ethylene/α-olefin multi-block copolymer is an ethylene/1-octene multi-block copolymer (consisting only of ethylene and octene comonomer) and has one, some, or all of the following properties:
(i) a Mw/Mn from 1.7, or 1.8 to 2.2, or 2.5, or 3.5; and/or
(ii) a density from 0.860 g/cc, or 0.865 g/cc, to 0.870 g/cc, or 0.877 g/cc, or 0.880 g/cc; and/or
(iii) a melting point, Tm, from 115° C., or 118° C., or 119° C., or 120° C. to 120° C., or 123° C., or 125° C.; and/or
(iv) a melt index (MI) from 0.1 g/10 min, or 0.5 g/10 min to 1.0 g/10 min, or 2.0 g/10 min, or 5 g/10 min, or 10 g/10 min; and/or
(v) from 50 to 85 wt % soft segment and from 40 to 15 wt % hard segment (based on total weight of the ethylene/octene multi-block copolymer); and/or
(vi) from 10 mol %, or 13 mol %, or 14 mol %, or 15 mol % to 16 mol %, or 17 mol %, or 18 mol %, or 19 mol %, or 20 mol % octene in the soft segment; and/or
(vii) from 0.5 mol %, or 1.0 mol %, or 2.0 mol %, or 3.0 mol % to 4.0 mol %, or 5 mol %, or 6 mol %, or 7 mol %, or 9 mol % octene in the hard segment; and/or
(viii) an elastic recovery (Re) from 50%, or 60% to 70%, or 80%, or 90%, at 300% min⁻¹ deformation rate at 21° C. as measured in accordance with ASTM D 1708; and/or
(ix) a polydisperse distribution of blocks and a polydisperse distribution of block sizes (hereafter referred to as multi-block copolymer properties (i)-(ix)).

In an embodiment, the ethylene/α-olefin multi-block copolymer is an ethylene/octene multi-block copolymer. The ethylene/octene multi-block copolymer is sold under the tradename INFUSE™, available from The Dow Chemical Company, Midland, Michigan, USA.

The ethylene/α-olefin multi-block copolymer can be produced via a chain shuttling process such as described in U.S. Pat. No. 7,858,706, which is herein incorporated by reference. In particular, suitable chain shuttling agents and related information are listed in col. 16 line 39 through col. 19 line 44. Suitable catalysts are described in col. 19 line 45 through col. 46 line 19 and suitable co-catalysts in col. 46 line 20 through col. 51 line 28. The process is described throughout the document, but particularly in col. 51 line 29 through col. 54 line 56. The process is also described, for example, in the following: U.S. Pat. Nos. 7,608,668; 7,893,166; and 7,947,793.

The ethylene/α-olefin multi-block copolymer may include more than one ethylene/α-olefin multi-block copolymer.

### B. Free Radical Initiator

The crosslinkable composition includes a free radical initiator. In an embodiment, the free radical initiator is an organic peroxide. Nonlimiting examples of suitable organic peroxide include bis(1,1-dimethylethyl) peroxide; bis(1,1-dimethylpropyl) peroxide; 2,5-dimethyl-2,5-bis(1,1-dimethylethylperoxy) hexane; 2,5-dimethyl-2,5-bis(1,1-dimethylethylperoxy) hexyne; 4,4-bis(1,1-dimethylethylperoxy) valeric acid; butyl ester; 1,1-bis(1,1-dimethylethylperoxy)-3,3,5-trimethylcyclohexane; benzoyl peroxide; tert-butyl peroxybenzoate; di-tert-amyl peroxide (“DTAP”); bis(α-t-butyl-peroxyisopropyl) benzene (“BIPB”); isopropylcumyl t-butyl peroxide; t-butylcumylperoxide; di-t-butyl peroxide; 2,5-bis(t-butylperoxy)-2,5-dimethylhexane; 2,5-bis(t-butylperoxy)-2,5-dimethylhexyne-3,1,1-bis(t-butylperoxy)-3,3,5-trimethylcyclohexane; isopropylcumyl cumylperoxide; butyl 4,4-di(tert-butylperoxy) valerate; di(isopropylcumyl) peroxide; dicumyl peroxide, and combinations thereof.

In an embodiment the free radical initiator is dicumyl peroxide.

### C. BiTEMPS Methacrylate Disulfide

The crosslinkable polymer composition includes 2,2,6,6-tetramethyl-4-piperidyl methacrylate disulfide, interchangeably referred to as “BiTEMPS methacrylate,” or “BiTEMPS” or “BiT.” BiTEMPS methacrylate disulfide has the Structure 1 below.

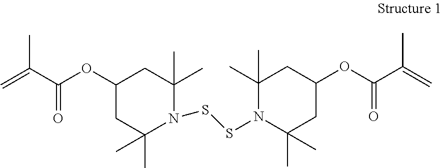 [SMILES: C=C(C)C(=O)OC1CC(C)(C)N(SSN2C(C)(C)CC(OC(=O)C(=C)C)CC2(C)C)C(C)(C)C1]

In an embodiment, the crosslinkable polymer composition includes
from 70 wt % to 98.5 wt %, or from 77 wt % to 98.5 wt % of the ethylene-based polymer;
from 0.5 wt % to 10 wt %, or from 0.5 wt % to 5 wt % 0.5 wt % to 3.0 wt % or from 0.5 wt % to 1.5 wt %, or from 1.5 wt % to 3.0 wt % free radical initiator that is an organic peroxide (such as dicumyl peroxide for example); and
from 1 wt % to 20 wt %, or from 1 wt % to 15 wt %, or from 3 wt % to 20 wt %, or from 3 wt % to 10 wt % BiTEMPS methacrylate disulfide. It is understood that the aggregate of the ethylene-based polymer, the free radical initiator, and the BiTEMPS methacrylate disulfide (and optional additives) amount to 100 wt % of the crosslinkable polymer composition.

The present disclosure provides a crosslinked composition. The crosslinkable polymer composition is melt blended at a temperature from 100° C. to 250° C., or from 120° C. to 200° C., or from 120° C. to 180° C., or from 120° C. to 160° C. to trigger the crosslinking reaction and form the crosslinked composition. In an embodiment, the crosslinked composition includes an ethylene-based polymer and 2,2,6,6-tetramethyl-4-piperidyl methacrylate disulfide (BiTEMPS methacrylate). The crosslinked composition contains disulfide linkages formed from the BiTEMPS methacrylate by way of the crosslinking reaction, the disulfide linkages having the Structure 2 below.

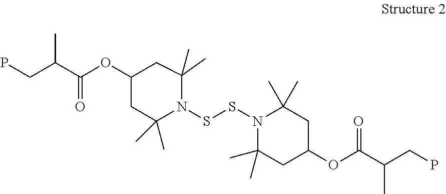

The term (and structure) “P” in Structure 2 above refers to the chain of polymerized ethylene (and optional comonomer(s)) for the ethylene-based polymer. The ethylene-based polymer of the crosslinked composition can be any ethylene-based polymer with a MI from 0.1 g/10 min to 100 g/10 min as previously disclosed herein. Nonlimiting examples of suitable ethylene-based polymer include ethylene plastomer/elastomer, high density polyethylene (HDPE), linear low density polyethylene (LLDPE), low density polyethylene (LDPE), ethylene/α-olefin multi-block copolymer, and combinations thereof.

In an embodiment, the ethylene-based polymer is a virgin ethylene-based polymer. A “virgin ethylene-based polymer,” as used herein, is an ethylene-based polymer that has not been subjected to a crosslinking reaction. In other words, the term “virgin ethylene-based polymer” refers to the ethylene-based polymer that is present in the crosslinked composition prior to the ethylene-based polymer being crosslinked with the BiTEMPS methacrylate. The virgin ethylene-based polymer is the ethylene-based polymer prior to crosslinking, the crosslinked composition containing the same ethylene-based polymer that was virgin, but is now crosslinked with BiTEMPS methacrylate. In this way, the virgin ethylene-based polymer serves as a baseline to evaluate the properties of the crosslinked composition. The crosslinked composition has
(i) a storage modulus value, E′, at 140° C. that is greater than the storage modulus value, E′, for the virgin ethylene-based polymer at 140° C.;
(ii) a tan delta value at 60° C. that is less than the tan delta value of the virgin ethylene-based polymer at 60° C.; and
(iii) a tan delta value at 140° C. that is less than the tan delta value of the virgin ethylene-based polymer at 140° C.

In an embodiment, the crosslinked composition includes from 80 wt % to 97 wt % of the ethylene-based polymer and from 3 wt % to 20 wt % BiTEMPS methacrylate, the aggregate of the ethylene-based polymer and the BiTEMPS methacrylate (and optional additives) amounting to 100 wt % of the crosslinked composition. The crosslinked composition has
(i) a storage modulus value, E′, at 60° C. greater than 1 MPa;
(ii) a storage modulus value, E′, at 140° C. greater than 0.1 MPa;
(iii) a tan delta value at 60° C. less than 0.17; and
(iv) a tan delta value at 140° C. less than 0.62.

### D. Blend Component

In an embodiment, the crosslinkable composition and/or the crosslinked composition includes a blend component. Nonlimiting examples of suitable blend component include ethylene vinyl acetate (EVA), polyolefins (e.g., polyethylene other than the ethylene-based polymer crosslinked with BiTEMPS methacrylate and polypropylene), polymers (e.g., polystyrene, ABS, SBS and the like) and combinations thereof. Non-limiting examples of suitable polyolefins include polyethylene; polypropylene; polybutylene (e.g., polybutene-1); polypentene-1; polyhexene-1; polyoctene-1; polydecene-1; poly-3-methylbutene-1; poly-4-methylpentene-1; polyisoprene; polybutadiene; poly-1,5-hexadiene; interpolymers derived from olefins; interpolymers derived from olefins and other polymers such as polyvinyl chloride, polystyrene, polyurethane, and the like; and mixtures thereof.

In an embodiment, the polyolefin is a homopolymer such as polyethylene, polypropylene, polybutylene, polypentene-1, poly-3-methylbutene-1, poly-4-methylpentene-1, polyisoprene, polybutadiene, poly-1,5-hexadiene, polyhexene-1, polyoctene-1 and polydecene-1.

Nonlimiting examples of suitable polyethylene as blend component (other than the ethylene-based polymer that is crosslinked with BITEMPS methacrylate) include ultra low density polyethylene (ULDPE), linear low density polyethylene (LLDPE), low density polyethylene (LDPE), medium density polyethylene (MDPE), high density polyethylene (HDPE), high molecular weight high density polyethylene (HMW-HDPE), ultra high molecular weight polyethylene (UHMW-PE) and combinations thereof. Nonlimiting examples of polypropylene include low density polypropylene (LDPP), high density polypropylene (HDPP), high-melt strength polypropylene (HMS-PP) and combination thereof. In an embodiment, the blend component is a high-melt-strength polypropylene (HMS-PP), a low density polyethylene (LDPE) or a combination thereof.

### E. Additives

The crosslinkable composition and/or the crosslinked composition may contain one or more optional additives. Nonlimiting examples of suitable additives include grafting initiators, cross-linking catalysts, blowing agent, blowing agent activators (e.g., zinc oxide, zinc stearate and the like), coagents (e.g., triallyl cyanurate), plasticizers, processing oils, processing aids, carbon black, colorants or pigments, stability control agents, nucleating agents, fillers, antioxidants, acid scavengers, ultraviolet (UV) stabilizers, flame retardants, lubricants, processing aids, extrusion aids, and combinations thereof. When present, the total amount of additive can be from greater than 0 to 80%, or from 0.001% to 70%, or from 0.01% to 60%, or from 0.1% to 50%, or from 0.1% to 40%, or from 0.1% to 20%, or from 0.1% to 10%, or from 0.1% to 5% of the total weight of the composition.

In an embodiment, the crosslinkable composition and/or the crosslinked composition includes an antioxidant. Non-limiting examples of suitable antioxidants include aromatic or hindered amines such as alkyl diphenylamines, phenyl-a-naphthylamine, alkyl or aralkyl substituted phenyl-a-naphthylamine, alkylated p-phenylene diamines, tetramethyl-diaminodiphenylamine and the like; phenols such as 2,6-di-t-butyl-4-methylphenol; 1,3,5-trimethyl-2,4,6-tris(3′,5,-di-t-butyl-4,-hydroxybenzyl)benzene; tetrakis[(methylene(3,5-di-t-butyl-4-hydroxyhydrocinnamate)]methane (e.g., IRGANOX™ 1010, from Ciba Geigy, New York); acryloyl modified phenols; octadecyl-3,5-di-t-butyl-4-hydroxycinnamate (e.g., IRGANOX™ 1076, commercially available from Ciba Geigy); phosphites and phosphonites; hydroxylamines; benzofuranone derivatives; and combinations thereof. Where used, the amount of the antioxidant in the composition can be from greater than 0 to 5 wt %, or from 0.0001 to 2.5 wt %, or from 0.001 to 1 wt %, or from 0.001 to 0.5 wt % of the total weight of the composition.

In an embodiment, the crosslinkable composition and/or the crosslinked composition includes a UV stabilizer. Non-limiting examples of suitable UV stabilizers include benzophenones, benzotriazoles, aryl esters, oxanilides, acrylic esters, formamidines, carbon black, hindered amines, nickel quenchers, hindered amines, phenolic antioxidants, metallic salts, zinc compounds and combinations thereof. Where used, the amount of the UV stabilizer can be from greater than 0 to 5 wt %, or from 0.01 wt % to 3 wt %, or from 0.1 wt % to 2 wt %, or from 0.1 wt % to 1 wt % of the total weight of the composition.

In an embodiment, the crosslinkable composition and/or the crosslinked composition includes a colorant or a pigment. Non-limiting examples of suitable colorants or pigments include inorganic pigments such as metal oxides such as iron oxide, zinc oxide, and titanium dioxide, mixed metal oxides, carbon black, organic pigments such as anthraquinones, anthanthrones, azo and monoazo compounds, arylamides, benzimidazolones, BONA lakes, diketopyrrolo-pyrroles, dioxazines, disazo compounds, diarylide compounds, flavanthrones, indanthrones, isoindolinones, isoindolines, metal complexes, monoazo salts, naphthols, b-naphthols, naphthol AS, naphthol lakes, perylenes, perinones, phthalocyanines, pyranthrones, quinacridones, and quinophthalones, and combinations thereof. Where used, the amount of the colorant or pigment in the composition can be from greater than 0 to 10 wt %, or from 0.1 wt % to 5 wt %, or from 0.25 wt % to 2 wt % of the total weight of the composition.

In an embodiment, the crosslinkable composition and/or the crosslinked composition includes a filler. Nonlimiting examples of suitable fillers include talc, calcium carbonate, chalk, calcium sulfate, clay, kaolin, silica, glass, fumed silica, mica, wollastonite, feldspar, aluminum silicate, calcium silicate, alumina, hydrated alumina such as alumina trihydrate, glass microsphere, ceramic microsphere, thermoplastic microsphere, barite, wood flour, glass fibers, carbon fibers, marble dust, cement dust, magnesium oxide, magnesium hydroxide, antimony oxide, zinc oxide, barium sulfate, titaniumdioxide, titanates and combinations thereof.

In an embodiment, the filler is barium sulfate, talc, calcium carbonate, silica, glass, glass fiber, alumina, titanium dioxide, or a mixture thereof. In a further embodiment, the filler is talc, calcium carbonate, barium sulfate, glass fiber or a mixture thereof. Where used, the amount of the filler in the composition can be from greater than 0 to 80 wt %, or from 0.1 to 60 wt %, or from 0.5 to 40 wt %, or from 1 to 30 wt %, or from 10 to 40 wt % of the total weight of the composition.

In an embodiment, the crosslinkable composition and/or the crosslinked composition includes a lubricant. Nonlimiting examples of suitable lubricants include fatty alcohols and their dicarboxylic acid esters, fatty acid esters of short chain alcohols, fatty acids, fatty acid amides, metal soaps, oligomeric fatty acid esters, fatty acid esters of long-chain alcohols, montan waxes, polyethylene waxes, polypropylene waxes, natural and synthetic paraffin waxes, fluoropolymers and combinations thereof. Where used, the amount of the lubricant in the composition can be from greater than 0 wt % to 5 wt %, or from 0.1 to 4 wt %, or from 0.1 wt % to 3 wt % of the total weight of the composition.

In an embodiment, the crosslinkable composition and/or the crosslinked composition includes an antistatic agent. Non-limiting examples of suitable antistatic agents include conductive fillers (e.g., carbon black, metal particles and other conductive particles), fatty acid esters (e.g., glycerol monostearate), ethoxylated alkylamines, diethanolamides, ethoxylated alcohols, alkylsulfonates, alkylphosphates, quaternary ammonium salts, alkylbetaines and combinations thereof. Where used, the amount of the antistatic agent in the composition can be from greater than 0 wt % to 5 wt %, or from 0.01 to 3 wt %, or from 0.1 to 2 wt % of the total weight of the composition.

In an embodiment, the crosslinkable composition and/or the crosslinked composition includes a blowing agent. A “blowing agent” is a substance that is capable of producing a cellular structure in the composition via a foaming process. The blowing agent is used for foaming the crosslinked composition. Nonlimiting examples of suitable blowing agent include an inorganic physical blowing agent, such as air, argon, nitrogen, carbon dioxide, argon, helium, oxygen, and neon, and an organic physical blowing agent, such as an aliphatic hydrocarbon, e.g., propane, n-butane, isobutane, n-pentane, isopentane, and n-hexane, an alicyclic hydrocarbon, e.g., cyclohexane and cyclopentane, a halogenated hydrocarbon, e.g., chlorofluoromethane, trifluoromethane, 1,1-difluoroethane, 1,1,1,2-tetrafluoroethane, methyl chloride, ethyl chloride, and methylene chloride, and a dialkyl ether, e.g., dimethyl ether, diethyl ether, and methyl ethyl ether.

Non-limiting examples of suitable organic blowing agents include aliphatic hydrocarbons having 1-6 carbon atoms, aliphatic alcohols having 1-3 carbon atoms, and fully and partially halogenated aliphatic hydrocarbons having 1-4 carbon atoms. Non-limiting examples of suitable aliphatic hydrocarbons include methane, ethane, propane, n-butane, isobutane, n-pentane, isopentane, neopentane, and the like. Non-limiting examples of suitable aliphatic alcohols include methanol, ethanol, n-propanol, and isopropanol. Non-limiting examples of suitable fully and partially halogenated aliphatic hydrocarbons include fluorocarbons, chlorocarbons, and chlorofluorocarbons. Non-limiting examples of suitable fluorocarbons include methyl fluoride, perfluoromethane, ethyl fluoride, 1,1-difluoroethane (HFC152a), 1,1,1-trifluoroethane (HFC-143a), 1,1,1,2-tetrafluoroethane (HFC-134a), pentafluoroethane, difluoromethane, perfluoroethane, 2,2-difluoropropane, 1,1,1-trifluoropropane, perfluoropropane, dichloropropane, difluoropropane, perfluorobutane, perfluorocyclobutane. Non-limiting examples of suitable partially halogenated chlorocarbons and chlorofluorocarbons include methyl chloride, methylene chloride, ethyl chloride, 1,1,1-trichloroethane, 1,1-dichloro-1-fluoroethane (HCFC-141b), 1-chloro-l,ldifluoroethane (HCFC-142b), 1,1-dichloro-2,2,2-trifluoroethane (HCFC-123) and 1-chloro-1,2,2,2-tetrafluoroethane (HCFC-124). Non-limiting examples of suitable fully halogenated chlorofluorocarbons include trichloromonofluoromethane (OPOI 1), dichlorodifluoromethane (CFO-12), trichlorotrifluoroethane (CFO-113), 1,1,1-trifluoroethane, pentafluoroethane, dichlorotetrafluoroethane (CFO-114), chloroheptafluoropropane, and dichlorohexafluoropropane. Non-limiting examples of suitable chemical blowing agents include azodicarbonamide, azodiisobutyro-nitrile, benezenesulfonhydrazide, 4,4-oxybenzene sulfonyl-semicarbazide, p-toluene sulfonyl semi-carbazide, barium azodicarboxylate, N,N′-dimethyl-N,N′-dinitrosoterephthalamide, and trihydrazino triazine.

BiTEMPS methacrylate is a “dynamic crosslinker.” The dynamic crosslinker BiTEMPS methacrylate enables formation of a crosslinked network with the ethylene-based polymer by way of disulfide linkages between the chains of the ethylene-based polymer (in the presence of the free radical initiator) to form the crosslinked ethylene-based polymer composition. The crosslinking is dynamic because the disulfide linkages may be broken, allowing for chain mobility and exchange when the crosslinked ethylene-based polymer composition is subjected to a “reprocessing temperature,” the reprocessing temperature being a temperature from 120° C. to 160° C., or from 130° C. to 160° C. At the reprocessing temperature, the disulfide linkages in the crosslinked ethylene-based polymer composition are broken, forming a re-processable ethylene-based polymer composition. Cooling the re-processable ethylene-based composition below the reprocessing temperature forms a re-crosslinked ethylene-based polymer composition.

The dynamic crosslinker BiTEMPS methacrylate enables a cyclic “reprocessing” for fabrication of new polymeric articles. When the crosslinked ethylene-based polymer composition is heated to the reprocessing temperature, the disulfide linkages break, or otherwise cleave, enabling the previously-crosslinked ethylene-based polymer composition to flow at the reprocessing temperature, forming “a re-processable ethylene-based polymer composition.” Heating to the reprocessing temperature enables link breaking and polymer chain flow, allowing the ethylene-based composition to be reshaped readily. At the reprocessing temperature, the re-processable ethylene-based polymer composition is no longer crosslinked, but rather is flowable, enabling shaping and/or fabrication of the now flowable re-processable ethylene-based composition (with BiTEMPS methacrylate) into a new pre-form or article. Upon cooling to below the “reprocessing temperature,” the disulfide linkages form again, the network is re-established, and the re-crosslinked ethylene-based compositions is formed in the new article configuration with a return to the high viscosity (no flow at room temperature) and resistance to mechanical deformation indicative of the crosslinked network. When the newly-formed article of the re-processable ethylene-based polymer composition is cooled below the reprocessing temperature, the disulfide linkages in the re-processable ethylene-based polymer composition are re-established, and the ethylene-based polymer (with BiTEMPS methacrylate) becomes a re-crosslinked ethylene-based polymer composition in the shape of the newly-fabricated article. Below the reprocessing temperature, the network disulfide linkages are stable, and the re-crosslinked ethylene-based polymer composition exhibits the high viscosity and resistance to mechanical deformation indicative of a crosslinked network. This cycle of crosslink/re-process/re-crosslink and fabrication into a new article can be repeated.

Bounded by no particular theory, the number of “reprocessing” cycles that are possible with the present crosslinked ethylene-based composition (before competitive thermal and oxidative permanent crosslinking occurs and prevents further reprocessing), can be determined by calculating the ratio of the melt viscosity of the crosslinked ethylene-based polymer composition before and after a reprocessing cycle. For the crosslinked ethylene-based polymer composition to be re-processable, the ratio of the Mooney viscosity after reprocessing to the Mooney viscosity before reprocessing is from 0.5 to 5, or from 0.7 to 3 or from 0.9 to 2 or from 0.95 to 1.2.

Other metrics for monitoring the number of “reprocessing” cycles that are possible with the BiTEMPS methacrylate dynamic crosslinker before competitive oxidative permanent crosslinking occurs include visual observation. Formed film that is mechanically deformed is heated to the reprocessing temperature, and is visually inspected to determine whether the mechanically deformed film heals to form a stable film. This metric of re-processability is noted in Table 2 below.

The present disclosure provides a process. In an embodiment, the process includes heating a first article to a reprocessing temperature. The first article is composed of a crosslinked ethylene-based polymer composition comprising (i) an ethylene-based polymer; and (ii) 2,2,6,6-tetramethyl-4-piperidyl methacrylate disulfide (BiTEMPS methacrylate). The process includes forming, at the reprocessing temperature, the first article into a re-processable ethylene-based polymer composition. The process includes shaping, at the reprocessing temperature, the re-processable ethylene-based composition into a re-processed pre-form. The process includes cooling the re-processed pre-form to below the reprocessing temperature and forming a second article composed of a re-crosslinked ethylene-based polymer composition composed of (i) the ethylene-based polymer and (ii) the BiTEMPS methacrylate, the second article different than the first article.

In an embodiment, the shaping step is a procedure selected from the group consisting of injection molding, extrusion molding, thermoforming, slushmolding, over molding, insert molding, blow molding, cast molding, tentering, compression molding, and combinations thereof.

Nonlimiting examples of suitable articles (first article and second article) for the present crosslinked/re-crosslinked ethylene-based polymer (with BiTEMPS methacrylate) composition include elastic film; elastic fiber; soft touch good, such as tooth brush handles and appliance handles; gaskets and profiles; adhesives (including hot melt adhesives and pressure sensitive adhesives); footwear (including shoe soles and shoe liners); auto interior parts and profiles; foam articles (both open cell foam and closed cell foam); impact modifiers for other thermoplastic polymers such as high density polyethylene, isotactic polypropylene, or other olefin polymers; coated fabrics; hoses; tubing; weather stripping; cap liners; flooring; and combinations thereof.

By way of example, and not limitation, some embodiments of the present disclosure will now be described in detail in the following examples.

### 1. Materials

Materials used in the comparative samples (CS) and inventive examples (IE) are provided in Table 1 below.

TABLE 1

| Name | Structure/properties | Source |
|---|---|---|
| Polymer 1 DMDA 6200 | HDPE - ethylene homopolymer | The Dow Chemical |
| | d - 0.953 g/cc, <1 MI (I21 = 33) | Company |
| Polymer 2 DOWLEX ™ 2045G | LLDPE - ethylene homopolymer | The Dow Chemical |
| | d - 0.920 g/cc, MI - 1.0 g/10 min | Company |
| Polymer 3 ENGAGE ™ 8003 | Ethylene/octene random copolymer | The Dow Chemical |
| | d - 0.885 g/cc, MI - 1.0 g/10 min | Company |
| Polymer 4 ENGAGE ™ 8100 | Ethylene/octene random copolymer | The Dow Chemical |
| | d- 0.870 g/cc, MI - 1.0 g/10 min | Company |
| Polymer 5 ENGAGE ™ 8200 | Ethylene/octene random copolymer | The Dow Chemical |
| | d - 0.870 g/cc, MI - 5.0 g/10 min | Company |
| Polymer 6 ENGAGE ™ 8842 | Ethylene/octene random copolymer | The Dow Chemical |
| | d - 0.857 g/cc, MI - 1.0 g/10 min | Company |
| Polymer 7 INFUSE ™ 9100 | Ethylene/octene multi-block copolymer | The Dow Chemical |
| | d - 0.877 g/cc, MI - 1.0 g/10 min | Company |
| Polymer 8 INFUSE ™ 9107 | Ethylene/octene multiblock copolymer | The Dow Chemical |
| | d - 0.877 g/cc, MI - 1.0 g/10 min | Company |
| Polymer 9 INFUSE ™ 9530 | Ethylene/octene multiblock copolymer | The Dow Chemical |
| | d - 0.887 g/cc, MI - 5.0 g/10 min | Company |
| Polymer 10 LDPE 5004i | LDPE - ethylene homopolymer | The Dow Chemical |
| | d - 0.924 g/cc, MI - 4.0 g/10 min | Company |
| BiTEMPS methacrylate | 2,2,6,6-tetramethyl-4-piperidyl methacrylate disulfide | Custom synthesis |
| crosslinker | (Structure 1) C₂₆H₄₄N₂O₄S₂ | |
| Dicumyl Peroxide (“DCP”) | C₁₈H₂₂O₂ | Sigma-Aldrich |
| Radical initiator | | |

### 1. Synthesis of BiTEMPS Methacrylate

To synthesize BiTEMPS methacrylate, 2,2,6,6-tetramethyl-4-piperidyl methacrylate (8.78 g, 39.0 mmol, supplied by TO America) is first dissolved in anhydrous petroleum ether (˜90 mL, supplied by Sigma-Aldrich, dried over molecular sieves for 48 hr before use) and cooled to −70° C. in a dry ice/acetone bath. Afterward, sulfur monochloride (1.30 g, 9.7 mmol, supplied by Sigma-Aldrich) is dissolved in anhydrous petroleum ether (˜1.25 mL) and added dropwise to the reaction vessel over the course of 30 minutes. The solution is stirred at −70° C. for an additional 30 minutes and at room temperature for 15 minutes. Next, BiTEMPS methacrylate is precipitated out by pouring the reaction solution into copious distilled water and stirring at room temperature overnight. The precipitates are collected, vacuum-filtered, and vacuum-dried at 60° C. for 48 hr to obtain BiTEMPS methacrylate, shown as Structure 1 below.

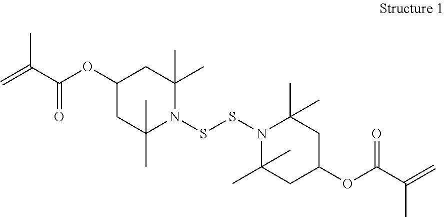

### 2. Preparation of Crosslinked Compositions

Appropriate masses of starting materials including polymer pellets (ethylene-based polymer), crosslinker (BiTEMPS methacrylate), and radical initiator (DCP) are massed separately on an analytical balance (typically, 2 g of polymer, 0.1 g of crosslinker, and 0.02 g of radical initiator). Prior to synthesis, the cup of a Dynisco (formerly Atlas) Laboratory Mixing Molder (LMM) is flushed of impurities by loading the polymer of interest, heating to above its melt transition, and mixing for 3-5 minutes. After removing the polymer debris from flushing, the massed polymer pellets and the powder mixture of crosslinker and radical initiator are added via spatula into the cup. The starting materials are added in doses such that they are evenly distributed throughout the cup prior to mixing. Additionally, three steel balls (˜5 mm diameter) are added evenly to the cup to emulate extrusion processes during melt-state mixing. Next, the temperature of the LMM is increased above the melt transition of the polymer, and the starting materials are mixed at this temperature at 120 rpm (maximum rotational speed) for 3-5 minutes to ensure homogenization of the ingredients in the melt state while minimizing radical initiation. For Polymers 4-6, this mixing temperature is 100° C. For Polymers 2 and 7-10, this mixing temperature is 130° C. For Polymer 1, this mixing temperature is 140° C. After this homogenization, the temperature of the LMM is ramped to 160° C. to commence radical initiation and crosslinker grafting processes. Mixing occurs at this temperature for approximately 20 minutes. During mixing, the rotor of the LMM is manually cycled upwards and downwards periodically to facilitate homogenization of the blend. After mixing for 20 minutes, mixing is ceased, and the crosslinked polymer blend is removed from the cup via spatula.

Crosslinked compositions (network blends) are cut into pieces and compression molded into films with dimensions 50 mm in length, 25 mm in width, and 0.65 mm thick in a PHI press (Model 0230C-X1) at 160° C. and 8 MPa for 30 minutes to obtain 1^{st}-molded samples. Films are cut into millimeter-sized pieces and compression molded at the same conditions to obtain 2^{nd}-molded samples, and this procedure is repeated again to obtain 3^{rd}-molded samples. Strips are cut from each sample film for dynamic mechanical analysis (DMA). 3. Polymer 7 (INFUSE™ 9100)

IE1 of Polymer 7 (INFUSE™ 9100) was selected to demonstrate the thermal property recovery by collecting DSC data after each successive compression molding recycle (up to three) (Table 4). A 10° C./min heating rate and a −40° C./min cooling rate were adapted for all measurements in a temperature range of −60° C. to 160° C.

Processability of Polymer 7 (INFUSE™ 9100) crosslinked compositions (network blends) were assessed by film quality after completing aforementioned standard compression molding procedure and conditions in Table 2 (below). Thermomechanical properties of Polymer 7 (INFUSE™ 9100) crosslinked compositions (network blends) were also tested via DMA to assess network responses for 1^{st}-molded samples compared to virgin Polymer 7 (INFUSE™ 9100) material. Hence, performance criteria are based on the virgin Polymer 7's properties.

TABLE 2
Polymer 7 (INFUSE ™ 9100)

| [symbol] edient | SI | | | | | | | |
|---|---|---|---|---|---|---|---|---|
| [symbol] e/Calculations | Units | CS1 | CS2 | CS3 | CS4 | CS5 | CS6 | CS7 |
| [symbol] mer 7 (INFUSE ™ | g | 2 | 2 | 2 | 2 | 2 | 2 | 2 |
| [symbol] 0) | | | | | | | | |
| [symbol] sslinker) | g | 0 | 0.1 | 0 | 0.02 | 0.1 | 0.1 | 0.1 |
| [symbol] ical initiator) | g | 0 | 0 | 0.02 | 0.02 | 0.005 | 0.03 | 0.04 |
| [symbol] polymer content | wt % | 0 | 5 | 0 | 1 | 5 | 5 | 5 |
| [symbol] /polymer | wt % | 0 | 0 | 1 | 1 | 0.25 | 1.5 | 2 |
| [symbol] tent | | | | | | | | |
| [symbol] ed Property | | | | | | | | |
| [symbol] cessability*/Film | >1 | 3 | 3 | 1 | 1 | 3 | 1 | 1 |
| [symbol] lity | | | | | | | | |
| [symbol] : 60° C. (<Tₘ) | >1 | 1.35 | N/A | N/A | N/A | 15.0 | N/A | N/A |
| [symbol] a) | MPa | | | | | | | |
| [symbol] : 140° C. (>Tₘ) | >0.1 | 0.00208 | N/A | N/A | N/A | 0.0592 | N/A | N/A |
| [symbol] a) | MPa | | | | | | | |
| [symbol] δ at 60° C. | <0.17 | 0.17 | N/A | N/A | N/A | 0.13 | N/A | N/A |
| [symbol] δ at 140° C. | <0.62 | 0.62 | N/A | N/A | N/A | 0.67 | N/A | N/A |

| [symbol] edient | SI | | | | | | | | | |
|---|---|---|---|---|---|---|---|---|---|---|
| [symbol] e/Calculations | Units | CS8 | CS9 | IE1 | IE2 | IE3 | IE4 | IE5 | IE6 | IE7 |
| [symbol] mer 7 (INFUSE ™ | g | 2 | 2 | 2 | 2 | 2 | 2 | 2 | 2 | 2 |
| [symbol] 0) | | | | | | | | | | |
| [symbol] sslinker) | g | 0.1 | 0.1 | 0.1 | 0.06 | 0.2 | 0.4 | 0.1 | 0.1 | 0.1 |
| [symbol] ical initiator) | g | 0.06 | 0.1 | 0.02 | 0.02 | 0.02 | 0.02 | 0.01 | 0.015 | 0.025 |
| [symbol] polymer content | wt % | 5 | 5 | 5 | 3 | 10 | 20 | 5 | 5 | 5 |
| [symbol] /polymer | wt % | 3 | 5 | 1 | 1 | 1 | 1 | 0.5 | 0.75 | 1.25 |
| [symbol] tent | | | | | | | | | | |
| [symbol] ed Property | | | | | | | | | | |
| [symbol] cessability*/Film | >1 | 1 | 1 | 3 | 2 | 3 | 3 | 3 | 3 | 2 |
| [symbol] lity | | | | | | | | | | |
| [symbol] : 60° C. (<Tₘ) | >1 | N/A | N/A | 18.0 | 16.6 | 18.3 | 17.0 | 15.6 | 17.1 | 16.1 |
| [symbol] a) | MPa | | | | | | | | | |
| [symbol] : 140° C. (>Tₘ) | >0.1 | N/A | N/A | 0.992 | 0.813 | 0.736 | 0.362 | 0.299 | 0.604 | 1.11 |
| [symbol] a) | MPa | | | | | | | | | |
| [symbol] δ at 60° C. | <0.17 | N/A | N/A | 0.10 | 0.10 | 0.11 | 0.13 | 0.12 | 0.11 | 0.097 |
| [symbol] δ at 140° C. | <0.62 | N/A | N/A | 0.18 | 0.21 | 0.31 | 0.62 | 0.56 | 0.34 | 0.15 |

For processability, 1-Network blend is not processable; pieces do not heal to form cohesive film for property testing.
2-Network blend is partially processable; pieces heal partially and require more time to heal fully. Resulting films are intact to enable property testing.
3-Network blend is fully processable; pieces heal completely, allowing for exhaustive property testing and recycling.
N/A-Sample was not tested due to lack of processability (CS3-4, CS6-9) or network response (CS2). [symbol]
indicates data missing or illegible when filed

Table 2 (above) shows inventive examples (IE) and comparative samples of crosslinkable compositions containing Polymer 7 (INFUSE™ 9100) with varying amounts of BiTEMPS methacrylate (“BiT,” crosslinker) and varying amounts of dicumyl peroxide (“DCP,” radical initiator). The crosslinkable compositions in Table 2 are mixed in a Laboratory Mixing Molder (LMM) as described above to form crosslinked compositions. Each crosslinked composition sample is subsequently cut into pieces, each piece 50 mm in length, 25 mm in width, and 0.65 mm thick, and compression molded into mm-thick films in a PHI press (Model 0230C-X1) at 160° C. and 8 MPa for 30 minutes to obtain 1V-molded samples.

The properties of each crosslinked film sample are shown in Table 2 as “Tested Property.” In Table 2, a minimum E′ at 140° C. of 0.1 MPa demonstrates a network response (crosslinking) over the thermoplastic response of virgin Polymer 7 (Formulation CS1) with crosslinker and radical initiator. Typically, synthesizing dynamic networks via the described procedures is successful for most polymers using 5 wt % crosslinker and 1 wt % radical initiator. Table 2 shows (i) the amount of radical initiator being varied while holding the amount of BiT crosslinker constant at 5 wt % crosslinker amount. Table 2 also shows (ii) varying the amount of BiT crosslinker while maintaining the amount of radical initiator constant at 1 wt %. This two-prong approach enabled the assessment of the limits for achieving a network response (crosslinking) for a model polymer (in this case, Polymer 7) while maintaining processability in a compression molder.

From Table 2, the viable ranges of crosslinker (BiT) and radical initiator (DCP) for Polymer 7 with respect to Polymer 7 loading mass are 3 wt % to 20 wt % and 0.5 to 1.25 wt %, respectively. These ranges give network responses (crosslinking) above 0.1 MPa at 140° C. and enable partial or full processability assessed through film quality after compression molding. In Table 2, crosslinked compositions IE1, IE3, IE4, IE5, and IE6 are fully processable (score of 3 for processability/film quality). IE1 (5 wt % crosslinker and 1 wt % radical initiator with respect to Polymer 7 loading mass of 2 g) yields an E′ value at 140° C. of 0.992 correlating to a strong dynamic network response. Comparative samples, CS1-CS9, in Table 2 either did not produce network materials due to insufficient crosslinker or radical initiator (CS1-2, 5) or were unable to be processed after compression molding due to overloading of radical initiator, forming permanent crosslinks incapable of dynamic chemistry (CS3-4, 6-9). Thus, Polymer7 (INFUSE™ 9100) materials synthesized from CS1-CS9 either flow above the melt transition temperature or cannot produce healed films, both of which prevent characterization via DMA.

Additionally, Polymer 7 (INFUSE™ 9100) IE1 Formulation was used to evaluate the minimum compression molding time needed for processing at 160° C. and 8 MPa in Table 3 below.

TABLE 3
Processability Time Testing Polymer 7 (INFUSE ™ 9100)

| Polymer | 10 | 15 | 20 | 25 | 30 |
|---|---|---|---|---|---|
| Network | minutes | minutes | minutes | minutes | minutes |
| Polymer 7 | 1 | 1 | 1 | 2 | 3 |
| (INFUSE ™ 9100) | | | | | |
| IE1 | | | | | |

Performance criteria >1

Table 3 (above) indicates that 25 minutes is the minimum amount of time required to process the Polymer 7 (INFUSE™ 9100) IE1 formulation partially at 160° C. and 8 MPa in a compression molder, and 30 minutes is the minimum amount of time required to process this formulation fully at the same conditions. This confirms the standard processing procedure for other polymers that includes a 30-minute pressing time.

Table 4 (below) shows the thermal properties of IE1 of Polymer 7 (INFUSE™ 9100) including as-synthesized material and three successive molding cycles tested by DSC to demonstrate their thermal property recoveries. IE1 of Polymer 7 restores its values of crystallinity and melting temperature ranges upon recycling relative to the as-synthesized network.

TABLE 4
Table 4: Thermal Properties Property Recovery of IE1 Formulations of Polymer
7 (INFUSE ™ 9100) as a Function of Processing Cycle

| Tested Property | Polymer Mold | Performance Criteria | Polymer 7 (INFUSE ™ 9100) |
|---|---|---|---|
| T_{m, peak} − T_{m, endpoint} | Virgin | | 122-132 |
| (° C.) | | | |
| | As-synthesized | ~<T_{m, peak} − T_{m, endpoint} of Virgin Polymer | 120-131 |
| | Network | | |
| | 1^{st} Mold | ~<T_{m, peak} − T_{m, endpoint} of Virgin Polymer | 118-128 |
| | 2^{nd} Mold | ~<T_{m, peak} − T_{m, endpoint} of Virgin Polymer | 118-130 |
| | 3^{rd} Mold | ~<T_{m, peak} − T_{m, endpoint} of Virgin Polymer | 118-129 |
| Crystallinity (%) | Virgin | | 16 |
| | As-synthesized | ~<Crystallinity of Virgin Polymer | 15 |
| | Network | | |
| | 1^{st} Mold | ~<Crystallinity of Virgin Polymer | 15 |
| | 2^{nd} Mold | ~<Crystallinity of Virgin Polymer | 15 |
| | 3^{rd} Mold | ~<Crystallinity of Virgin Polymer | 15 |

As shown in Table 4 above, IE1 of Polymer 7 restores its values of crystallinity and melting temperature ranges upon recycling relative to the as-synthesized network. 4. Polymers 1-10

Based on the findings for Polymer 7 (INFUSE™ 9100), the IE1 formulation for Polymer 7 (2 g polymer basis, 5 wt % crosslinker, 1 wt % radical initiator) was translated to Polymers 1-6 and 8-10. Sufficient network responses and full recoveries of thermomechanical properties evaluated using DMA after 3 successive compression molding cycles were obtained with this formulation for Polymers 1-6 and 8-10.

Table 5 is provided below.

TABLE 5
Thermomechanical Properties

| | | IE1 | IE2 | IE3 | IE4 | IE5 | IE6 | IE7 | IE8 | IE9 | IE10 |
|---|---|---|---|---|---|---|---|---|---|---|---|
| T [symbol] roperty | Polymer Mold | 6200 | 2045G | 8003 | 8100 | 8200 | 8842 | 9100 | 9107 | 9530 | 5004i |
| B [symbol] | | 5/1 | 5/1 | 5/1 | 5/1 | 5/1 | 5/1 | 5/1 | 5/1 | 5/1 | 10/3 |
| ( [symbol] | | | | | | | | | | | |
| E′ at 60° C. (MPa) | Virgin | | 125 | 8.21 | 2.66 | 1.92 | 0.80 | 13.5 | 6.51 | 17.5 | 93.3 |
| ~E′ of Virgin Polymer | 1^{st} Mold | 325 | 91 | 7.67 | 2.58 | 2.04 | 1.14 | 17.0 | 7.17 | 29.2 | 93.6 |
| ~≥E′ of 1^{st} Mold | 2^{nd} Mold | 365 | 87 | 7.57 | 2.60 | 1.83 | 1.20 | 17.3 | 7.37 | 26.0 | 98.0 |
| ~≥E′ of 1^{st} Mold | 3^{rd} Mold | 370 | 101 | 7.49 | 2.70 | 1.81 | 1.15 | 17.7 | 6.96 | 29.5 | 92.0 |
| E′ at 140° C. (MPa) | Virgin | | 0.002 | 0.001 | N/A | N/A | N/A | 0.002 | 0.001 | N/A | N/A |
| ~E′ of Virgin Polymer | 1^{st} Mold | 0.78 | 0.88 | 0.92 | 0.92 | 0.48 | 0.49 | 0.66 | 0.94 | 0.25 | 0.08 |
| ~≥E′ of 1^{st} Mold | 2^{nd} Mold | 1.08 | 1.06 | 0.96 | 0.90 | 0.50 | 0.45 | 0.74 | 0.97 | 0.29 | 0.12 |
| ~≥E′ of 1^{st} Mold | 3^{rd} Mold | 1.04 | 1.23 | 1.01 | 1.03 | 0.60 | 0.45 | 0.75 | 1.04 | 0.29 | 0.15 |
| tan δ at 60° C. | Virgin | | 0.21 | 0.068 | 0.13 | 0.20 | 0.49 | 0.17 | 0.20 | 0.17 | 0.24 |
| <tan δ of Virgin Polymer | 1^{st} Mold | 0.21 | 0.20 | 0.067 | 0.10 | 0.14 | 0.26 | 0.11 | 0.10 | 0.13 | 0.21 |
| ~tan δ of 1^{st} Mold | 2^{nd} Mold | 0.21 | 0.20 | 0.061 | 0.10 | 0.16 | 0.26 | 0.11 | 0.10 | 0.12 | 0.22 |
| ~tan δ of 1^{st} Mold | 3^{rd} Mold | 0.21 | 0.19 | 0.063 | 0.10 | 0.15 | 0.26 | 0.11 | 0.10 | 0.12 | 0.21 |
| tan δ at 140° C. | Virgin | | 0.98 | 1.0 | N/A | N/A | N/A | 0.62 | 1.56 | N/A | N/A |
| <tan δ of Virgin Polymer | 1^{st} Mold | 0.26 | 0.27 | 0.28 | 0.23 | 0.31 | 0.32 | 0.32 | 0.19 | 0.53 | 0.45 |
| ~tan δ of 1^{st} Mold | 2^{nd} Mold | 0.21 | 0.24 | 0.27 | 0.23 | 0.29 | 0.34 | 0.31 | 0.18 | 0.52 | 0.44 |
| ~tan δ of 1^{st} Mold | 3^{rd} Mold | 0.22 | 0.21 | 0.24 | 0.20 | 0.25 | 0.32 | 0.29 | 0.14 | 0.50 | 0.48 |
| T_{m, peak} − T_{m, endpoint} (° C.) | Virgin | 130-142 | 123-132 | 81-98 | 63-85 | 63-85 | 50-67 | 122-132 | 121-127 | 124-135 | 112-12 [symbol] |
| ~<T_{m, peak} − T_{m, endpoint} of | As-synthesized | 127-137 | 119-132 | 78-97 | 63-83 | 59-84 | 39-62 | 120-131 | 118-130 | 122-129 | 110-11 [symbol] |
| Virgin Polymer | Network | | | | | | | | | | |
| Crystallinity (%) | Virgin | 70 | 50 | 23 | 18 | 19 | 11 | 16 | 8 | 21 | 43 |
| ~<Crystallinity of | As-synthesized | 63 | 47 | 21 | 17 | 17 | 7 | 15 | 7 | 18 | 41 |
| Virgin Polymer | Network | | | | | | | | | | |

[symbol]

indicates data missing or illegible when filed

Table 5 exhibits E′ and tan δ at both 60° C. and 140° C. for the IE1 formulations of Polymers 1-10. E′ values at 60° C. of the network polymers are equal (on the same order of magnitude) to the E′ values of the respective virgin polymers within experimental uncertainty. Depending on the change in crystallinity after dynamic crosslinking and processing compared to the virgin polymers, E′ values at this temperature may be slightly smaller (decrease in crystallinity will decrease E′ below the melt transition despite enhancement from crosslinking) or slightly larger (crystallinity is marginally affected and crosslinking enhances E′). Successive molds at this temperature for each of the IE1 Polymer formulations exhibit E′ values approximately equal (on the same order of magnitude) to the E′ values of the respective virgin polymers and 1^{st}-molded samples within experimental uncertainty.

At 140° C., E′ values of the network polymers IE1-IE10 crosslinked compositions are larger than the E′ values of respective virgin Polymers 1-10, as the virgin Polymers 1-10 do not possess network characteristics that would give large E′ values (>0.1 MPa) above the melt transitions. Successive molds at 140° C. for each of the IE1-10 Polymer crosslinked compositions exhibit E′ values approximately equal (on the same order of magnitude) or slightly larger (from additional crosslink formation during processing) to the E′ values of the 1^{st}-molded samples within experimental uncertainty.

Coinciding with the larger presence of crosslinks in the network materials, tan S values at both 60° C. and 140° C. are smaller for the IE1-10 crosslinked compositions (network formulations) compared to their respective virgin counterparts Polymers 1-10. Additionally, these values are maintained for successively molded samples at both temperatures both 60° C. and 140° C. The IE1-10 crosslinked compositions presented in Table 5 demonstrate that Polymers 1-10 not only give substantial dynamic network responses upon crosslinking (>1 MPa at 60° C. and >0.1 MPa at 140° C.) but also are re-processable and recover their E′ and tan δ values after successive compression molding cycles. Comparative samples that are processable do not achieve substantial network responses, and comparative samples that give substantial network responses are unable to be reprocessed and do not recover thermomechanical properties after processing due to the presence of permanent crosslinks rather than sufficient dynamic crosslinks.

Table 5 provides the thermal properties (melting ranges and crystallinities) of the virgin Polymers 1-10 (comparative samples) and inventive examples IE1-10 crosslinked compositions (network formulations) determined by DSC. Reactive crosslinking diminishes the order of the crystal structures formed during cooling post-processing, slightly decreasing the crystallinities as well as decreasing melting peaks and endpoints of the network polymers compared to their virgin counterparts Polymers 1-10 (the comparative samples).

Table 6 below shows hot creep data for (i) virgin INFUSE™ 9100 ethylene/octene multi-block copolymer (comparative sample), (ii) crosslinked ethylene-based polymer composition composed of and 5 wt % BiTEMPS methacrylate, (IE7-1), (iii) virgin ENGAGE™ 8003 ethylene/octene random copolymer (comparative sample), and (iv) crosslinked ethylene-based composition composed of ENGAGE™ 8003, ethylene/octene random copolymer and 5 wt % BiTEMPS methacrylate (IE4-1).

TABLE 6

| Sample | Time at Break (minutes) |
|---|---|
| Virgin INFUSE ™ 9100 (CS) | <0:10 |
| INFUSE ™ 9100 (5 wt % BiTEMPS, 1 | 5:15 ± 2:50 |
| wt % DCP - (IE7-1) | |
| Virgin ENGAGE ™ 8003 (CS) | <0:10 |
| ENGAGE ™ 8003 (5 wt % BiTEMPS, 1 | 25:50 ± 12:20 |
| wt % DCP - (IE4-1) | |

It is specifically intended that the present disclosure not be limited to the embodiments and illustrations contained herein, but include modified forms of those embodiments including portions of the embodiments and combination of elements of different embodiments as come within the scope of the following claims.

1. A crosslinkable polymer composition comprising:
an ethylene-based polymer;
a free radical initiator; and
2,2,6,6-tetramethyl-4-piperidyl methacrylate disulfide (BiTEMPS methacrylate).

2. The crosslinkable polymer composition of claim 1 wherein the ethylene-based polymer has a melt index from 0.1 g/10 min to 100 g/10 min.

3. The crosslinkable polymer composition of claim 1 wherein the ethylene-based polymer is selected from the group consisting of ethylene plastomer/elastomer, high density polyethylene (HDPE), linear low density polyethylene (LLDPE), low density polyethylene (LDPE), ethylene/α-olefin multi-block copolymer, and combinations thereof.

4. The crosslinkable polymer composition of claim 1 wherein the free radical initiator is an organic peroxide.

5. The crosslinkable polymer composition of claim 1 comprising:
from 70 wt % to 98.5 wt % of the ethylene-based polymer;
from 0.5 wt % to 10.0 wt % free radical initiator; and
from 1 wt % to 20 wt % BiTEMPS methacrylate.

6. The crosslinkable polymer of claim 1 wherein the free radical initiator is dicumyl peroxide.

7. A crosslinked composition comprising:
an ethylene-based polymer; and
2,2,6,6-tetramethyl-4-piperidyl methacrylate disulfide (BiTEMPS methacrylate).

8. The crosslinked composition of claim 7 wherein the crosslinked composition comprises linkages of Structure 2

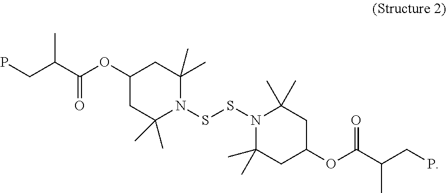

9. The crosslinked composition of claim 7 comprising
from 80 wt % to 99 wt % of an ethylene-based polymer having a melt index from 0.1 g/10 min to 100 g/10 min; and
from 20 wt % to 1 wt % of the BiTEMPS methacrylate.

10. The crosslinked composition of claim 7 wherein the ethylene-based polymer is selected from the group consisting of ethylene plastomer/elastomer, high density polyethylene (HDPE), linear low density polyethylene (LLDPE), low density polyethylene (LDPE), ethylene/α-olefin multi-block copolymer, and combinations thereof.

11. The crosslinked composition of claim 7 wherein
the ethylene-based polymer is a virgin ethylene-based polymer prior to the crosslinked composition being crosslinked; and
the crosslinked composition has
(i) a storage modulus value, E′, at 140° C. that is greater than the storage modulus value, E′, for the virgin ethylene-based polymer at 140° C.;
(ii) a tan delta value at 60° C. that is less than the tan delta value of the virgin ethylene-based polymer at 60° C.; and
(iii) a tan delta value at 140° C. that is less than the tan delta value of the virgin ethylene-based polymer at 140° C.

12. The crosslinked composition of claim 7 comprising:
from 3 wt % to 20 wt % BiTEMPS methacrylate; and
the crosslinked composition has
(i) storage modulus value, E′, at 60° C. greater than 1 MPa;
(ii) a storage modulus value, E′, at 140° C. greater than 0.1 MPa;
(iii) a tan delta value at 60° C. less than 0.17; and
(iv) a tan delta value at 140° C. less than 0.62.

13. A process comprising:
heating a first article to a reprocessing temperature, the first article composed of a crosslinked ethylene-based polymer composition comprising (i) an ethylene-based polymer; and (ii) 2,2,6,6-tetramethyl-4-piperidyl methacrylate disulfide (BiTEMPS methacrylate);
forming, at the reprocessing temperature, the first article into a re-processable ethylene-based polymer composition;
shaping, at the reprocessing temperature, the re-processable ethylene-based composition into a re-processed pre-form; and
cooling the re-processed pre-form to below the reprocessing temperature and forming a second article composed of a re-crosslinked ethylene-based polymer composition composed of (i) the ethylene-based polymer and (ii) the BiTEMPS methacrylate, the second article different than the first article.
